(19) United States
(12) Patent Application Publication
(10) Pub. No.: US 2024/0343603 A1
(43) Pub. Date: Oct. 17, 2024

(54) POSITIVE ELECTRODE ACTIVE MATERIAL, METHOD OF MANUFACTURING POSITIVE ELECTRODE ACTIVE MATERIAL, AND LITHIUM ION SECONDARY BATTERY

(71) Applicant: TOYOTA JIDOSHA KABUSHIKI KAISHA, Toyota-shi (JP)

(72) Inventors: So YUBUCHI, Shizuoka-ken (JP); Jun Yoshida, Mishima-shi (JP)

(73) Assignee: TOYOTA JIDOSHA KABUSHIKI KAISHA, Toyota-shi (JP)

(21) Appl. No.: 18/621,762

(22) Filed: Mar. 29, 2024

(30) Foreign Application Priority Data
Apr. 12, 2023 (JP) 2023-065097

(51) Int. Cl. C01G 53/00; H01M 10/0525

(52) U.S. Cl. CPC C01G 53/50; H01M 10/0525; C01P 2002/72; C01P 2004/51; C01P 2004/61

(57) ABSTRACT

Disclosed is a positive electrode active material having an O2 type structure and having a large capacity. The positive electrode active material of present disclosure includes Li containing oxide particles, wherein the Li containing oxide particles have O2 type structure and predetermined chemical composition. The Li containing oxide particles have a particle diameter D50 of more than 0 μm and 3.0 μm or less, a particle diameter D90 of 2.0 μm or more and 6.0 μm or less. The X-ray diffraction pattern of the Li containing oxide particles satisfies 0≤I₂/I₁≤0.5, wherein, I₁ is an X-ray diffraction peak intensity derived from (002) plane of O2 type structure, and I₂ is an X-ray diffraction peak intensity derived from (003) plane of O3 type structure.

### FIELD

The present application discloses a positive electrode active material, a method of manufacturing a positive electrode active material, and a lithium ion secondary battery.

### BACKGROUND

As a positive electrode active material, one having a O2 type structure is known. As disclosed in PTL 1, a positive electrode active material having a O2 type structure is obtained by ion-exchanging at least a part of Na of a Na containing oxide having a P2 type structure with Li.

### CITATION LIST

### Patent Literature

[PTL 1] JP 2010-092824 A

### SUMMARY

### Technical Problem

Conventional positive electrode active materials having O2 type structures have room for improved capacities.

### Solution to Problem

As a means for solving the above problem, the present application discloses the following plurality of aspects.

### <Aspect 1>

A positive electrode active material, comprising Li containing oxide particles, wherein
the Li containing oxide particles have O2 type structures,
the Li containing oxide particles have a chemical composition represented by LiₐNa_{b}Mnₓ₋ₚNi_{y-q}Co_{z-r}Mp_{+q+r}O₂ (where 0<a≤1.00, 0≤b<0.01, x+y+z=1, 0≤p+q+r<0.17, and element M is at least one of B, Mg, Al, K, Ca, Ti, V, Cr, Fe, Cu, Zn, Ga, Ge, Sr, Y, Zr, Nb, Mo and W),
the particle diameter D50 of the Li containing oxide particles is more than 0 μm and 3.0 μm or less,
the particle diameter D90 of the Li containing oxide particles is 2.0 μm or more and 6.0 μm or less, and
the X-ray diffraction pattern of the Li containing oxide particles satisfies 0≤I₂/I₁≤0.5, wherein
I₁ is X-ray diffraction peak intensity derived from (002) plane of the O2 type structure, and
I₂ is X-ray diffraction peak intensity derived from (003) plane of O3 type structure.

### <Aspect 2>

The positive electrode active material according to Aspect 1, wherein
the particle diameter D10 of the Li containing oxide particles is more than 0 μm and 2.0 μm or less.

### <Aspect 3>

A method of manufacturing a positive electrode active material, the method comprising:
obtaining precursor particles comprising at least one element of Mn, Ni and Co,
coating the surface of the precursor particles with a Na source to obtain composite particles,
main firing the composite particles to obtain Na containing oxide particles having P2 type structures, and
contacting an ion-exchange material with the Na containing oxide particles and ion-exchanging Na of the Na containing oxide particles with Li to obtain Li containing oxide particles having O2 type structures, wherein
the temperature of the main firing is 700° C. or higher and lower than 950° C.,
the particle diameter D50 of the Na containing oxide particles is more than 0 μm and 3.0 μm or less,
the particle diameter D90 of the Na containing oxide particles is 2.0 μm or more and 6.0 μm or less,
the temperature of the ion exchanging is the melting point of the ion-exchange material or more and 300° C. or less, and
the time of the ion exchanging is 30 μminutes or more and less than 3 hours.

### <Aspect 4>

The manufacturing method according to Aspect 3, wherein
the particle diameter D10 of the Na containing oxide particles is more than 0 μm and 2.0 μm or less.

### <Aspect 5>

A lithium ion secondary battery, comprising a positive electrode active material layer, an electrolyte layer, and a negative electrode active material layer, wherein
the positive electrode active material layer comprises the positive electrode active material according to Aspect 1 or 2.

### Effects

The positive electrode active material of the present disclosure has a O2 type structure and has a large capacity.

### BRIEF DESCRIPTION OF DRAWINGS

FIG. 1 shows an exemplary flow of a method of manufacturing a Li containing oxide having an O2 type structure.

FIG. 2 schematically shows an example of the configuration of the lithium ion secondary battery.

FIG. 3 shows the X-ray diffraction pattern of the positive electrode active material of Example 1.

FIG. 4 shows the X-ray diffraction patterns of each of the positive electrode active materials of Comparative Examples 1 to 3.

FIG. 5 shows the X-ray diffraction patterns of each of the positive electrode active material of Comparative Examples 4 and 5.

### DESCRIPTION OF EMBODIMENTS

### 1. Positive Electrode Active Material

The positive electrode active material according to an embodiment includes Li containing oxide particles. The Li containing oxide particles have O2 type structures. The Li containing oxide particles have a chemical composition represented by LiₐNa_{b}Mnₓ₋ₚNi_{y-q}Co_{z-r}M_{p+q+r}O₂ (where 0<a≤1.00, 0≤b<0.01, x+y+z=1, 0!p+q+r<0.17, and element M is at least one of B, Mg, Al, K, Ca, Ti, V, Cr, Fe, Cu, Zn, Ga, Ge, Sr, Y, Zr, Nb, Mo and W.). The particle diameter D50 of the Li containing oxide particles is more than 0 μm and 3.0 μm or less. The particle diameter D90 of the Li containing oxide particles is 2.0 μm or more and 6.0 μm or less. The X-ray diffraction pattern of the Li containing oxide particles satisfies 0≤I₂/I₁≤0.5, wherein I₁ is X-ray diffraction peak intensity derived from (002) plane of the O2 type structure, and I₂ is X-ray diffraction peak intensity derived from (003) plane of O3 type structure.

### 1.1 Crystal Structure

The Li containing oxide particle according to an embodiment has at least an O2 type structure (belonging to the space group P63mc) as a crystalline structure. The Li containing oxide particle according to an embodiment may have an O2 type structure and a crystalline structure other than O2 type structure. Examples of the crystal structure other than O2 type structure include a T #2 type structure (belonging to a space group Cmca) formed when a Li is de-inserted from the O2 type structure, an 06 type structure (belonging to a space group R-3m, and differing from an O3 type structure having a c-axis length of 2.5 nm or more and 3.5 nm or less, typically 2.9 nm or more, and also belonging to a space group R-3m), and the like. However, as will be described later, the Li containing oxide particle according to an embodiment substantially does not contain an O3 type structure or it is very small even if it contains an O3 type structure. The Li containing oxide particle according to an embodiment may have an O2 type structure as a main phase. The Li containing oxide particle according to an embodiment may have a T #2 type structure together with a O2 type structure. In the Li containing oxide particle according to an embodiment, the crystal-structure of the main phase may be changed depending on the charge-discharge state thereof.

As will be described later, the Li containing oxide particle having an O2 type structure is produced by ion-exchanging Na of a Na containing oxide particle having a P2 type structure with Li. According to the findings of the present inventor, when the particle diameter of Na containing oxide particle is large, Na tends to remain in the Li containing oxide particle after ion-exchange. On the other hand, when the particle diameter of Na containing oxide particle is small, Na is difficult to remain, but when the ion exchange time is not appropriate, an O3 type structure is easily generated together with an O2 type structure in the Li containing oxide particle after ion exchange. According to the findings of the present inventor, when the O3 type structure contained in Li containing oxide particles is large, the capacity as a positive electrode active material decreases. In other words, the lower the X-ray diffraction peak derived from the O3 type structure with respect to the X-ray diffraction peak derived from the O2 type structure, the larger the capacity as the positive electrode active material.

When the X-ray diffraction pattern of the Li containing oxide particle according to an embodiment is measured, the ratio I₂/I₁ of the X-ray diffraction peak intensity I₂ derived from the (003) plane (face) of the O3 type structure to the X-ray diffraction peak intensity I₁ derived from the (002) plane (face) of the O2 type structure is sufficiently small as 0.5 or less, so that the capacity as a positive electrode active material is large. The X-ray diffraction pattern may satisfy 0≤I₂/I₁≤0.4, 0≤I₂/I₁≤0.3, 0≤I₂/I₁≤0.2, 0≤I₂/I₁≤0.1, or I₂/I₁=0. In the present application, “X-ray diffraction pattern” and “X-ray diffraction peak intensity” of the Li containing oxide particle refer to those acquired under the following conditions. That is, with respect to the Li containing oxide particles, using an X-ray diffractometer (Rigaku, fully automated multi-purpose X-ray diffractometer SmartLab), CuKα as a radiation source, the tube voltage 45 kV, in the tube current 200 μmA, the step-width 0.02°, the scanning speed 1°/min at 2θ/θ scanning to obtain an X-ray diffraction pattern. From the X-ray diffraction pattern, the X-ray diffraction peak derived from the (002) plane of O2 type structure and the X-ray diffraction peak derived from the (003) plane of O3 type structure are identified, and after subtracting the background near the peak, the above I₂/I₁ can be determined from the intensity of each X-ray diffraction peak. Note that the position of the X-ray diffraction peak derived from the (002) plane of O2 type structure and the position of the X-ray diffraction peak derived from the (003) plane of O3 type structure may vary depending on Li content and the transition-metal composition.

### 1.2 Chemical Composition

The Li containing oxide particles according to an embodiment have a chemical composition represented by LiₐNa_{b}Mnₓ₋ₚNi_{y-q}Co_{z-r}M_{p+q+r}O₂ (where 0<a≤1.00, 0≤b<0.01, x+y+z=1, 0≤p+q+r<0.17, and element M is at least one of B, Mg, Al, K, Ca, Ti, V, Cr, Fe, Cu, Zn, Ga, Ge, Sr, Y, Zr, Nb, Mo and W). When the Li containing oxide particle has such a chemical composition, the O2 type structure is easily maintained. Further, when the composition ratio b of Na is less than 0.01, Na remaining in the Li containing oxide particle is sufficiently reduced, and the reversible capacity as the positive electrode active material is increased. In the above chemical composition, “a” is more than 0, and may be 0.10 or more, 0.20 or more, 0.30 or more, 0.40 or more, 0.50 or more, or 0.60 or more, and is 1.00 or less, and may be 0.90 or less, 0.80 or less, or 0.70 or less. In addition, “b” is 0.01 or less, and may be 0.00. Further, “x” is 0 or more, and may be 0.10 or more, 0.20 or more, 0.30 or more, 0.40 or more, or 0.50 or more, and is 1.00 or less, and may be 0.90 or less, 0.80 or less, 0.70 or less, 0.60 or less, or 0.50 or less. Further, “y” is 0 or more, and may be 0.10 or more or 0.20 or more, and is 1.00 or less, and may be 0.90 or less, 0.80 or less, 0.70 or less, 0.60 or less, 0.50 or less, 0.40 or less, 0.30 or less, or 0.20 or less. Further, “z” is 0 or more, and may be 0.10 or more, 0.20 or more, or 0.30 or more, and is 1.00 or less, and may be 0.90 or less, 0.80 or less, 0.70 or less, 0.60 or less, 0.50 or less, 0.40 or less, or 0.30 or less. Element M has small contribution to charge and discharge. In this regard, in the above chemical composition, p+q+r is less than 0.17, whereby it is easy to secure a high capacity. p+q+r may be 0.16 or less, 0.15 or less, 0.14 or less, 0.13 or less, 0.12 or less, 0.11 or less, or 0.10 or less. On the other hand, by containing the element M, the O2 type structure is easily stabilized. In addition, the presence of the element M does not substantially affect the problem solving mechanism by the positive electrode active material of the present disclosure. In other words, regardless of the presence of the element M, the O3 type structure in the Li containing oxide particle is small and the remaining Na is small, so that the reversible capacity as the positive electrode active material can be improved. In the above chemical composition, p+q+r is 0 or more, and may be 0.01 or more, 0.02 or more, 0.03 or more, 0.04 or more, 0.05 or more, 0.06 or more, 0.07 or more, 0.08 or more, 0.09 or more, or 0.10 or more. The composition of O is approximately 2, but is variable without being limited to exactly 2.0.

### 1.3 Particle Diameter

The particle diameter D50 of the Li containing oxide particles according to an embodiment is more than 0 μm and 3.0 μm or less, and the particle diameter D90 is 2.0 μm or more and 6.0 μm or less. As long as the Li containing oxide particles having such D50 and D90 are used, they tend to be those having a small amount of Na remaining as described above (b in the above chemical composition is less than 0.01). The particle diameter D50 of the Li containing oxide particles may be 0.2 μm or more and 2.8 μm or less, 0.4 μm or more and 2.6 μm or less, 0.6 μm or more and 2.4 μm or less, 0.8 μm or more and 2.2 μm or less, or 1.0 μm or more and 2.0 μm or less. In addition, the particle diameter D90 of the Li containing oxide particles may be 2.3 μm or more and 5.5 μm or less, 2.5 μm or more and 5.0 μm or less, 2.7 μm or more and 4.5 μm or less, or 2.9 μm or more and 4.0 μm or less. In addition, the particle diameter D10 of the Li containing oxide particles according to an embodiment may be greater than 0 μm and 2.0 μm or less. The particle diameter D10 μmay be 0.1 μm or more and 1.9 μm or less, 0.2 μm or more and 1.8 μm or less, 0.3 μm or more and 1.7 μm or less, 0.4 μm or more and 1.6 μm or less, or 0.5 μm or more and 1.5 μm or less. In the present application, the “particle diameter D50” is the particle diameter (median diameter) at an accumulated value of 50% in the particle size distribution on a volume basis by a laser diffraction/scattering method, the “particle diameter D90” is the particle diameter at an accumulated value of 90% in the particle size distribution on a volume basis by a laser diffraction/scattering method, and the “particle diameter D10” is the particle diameter at an accumulated value of 10% in the particle size distribution on a volume basis by a laser diffraction/scattering method.

### 1.4 Shape

As will be described later, the Li containing oxide particles having O2 type structures can be obtained by exchanging Na of the Na containing oxide particles having P2 type structures with Li. Here, P2 type structure is hexagonal and has a large diffusivity of Na ions whereby it is easy to grow crystals in a particular orientation. In particular, as the transition-metal element constituting P2 type structure, when at least one of Mn, Ni and Co is included, easily grow crystals in a plate-like to a particular direction. Therefore, Na containing oxide having a P2 type structure tends to be a plate-like particle having a large aspect ratio, in which the growing direction of the crystals is biased in a particular direction. The Li containing oxide according to an embodiment may be one obtained based on such plate-like Na containing oxide particles, or may be one obtained based on spherical Na containing oxide particles as described later. In other words, the shape of the Li content oxide particle may be plate-like or spherical. When the Li containing oxide particle is spherical, the reactive resistance decreases by reducing the crystallite size, and the diffusive resistance inside the particle tends to decrease. In addition, when applied to a secondary battery or the like, it is considered that the degree of bending is reduced by spheronization and the lithium ion conduction resistance is lowered. Thus, for example, the rate characteristics are improved, and the reversible capacity is easily increased. In the present application, “spherical particle” means particle having a circularity of 0.80 or more. The circularity of the particle may be 0.81 or more, 0.82 or more, 0.83 or more, 0.84 or more, 0.85 or more, 0.86 or more, 0.87 or more, 0.88 or more, 0.89 or more, or 0.90 or more. The circularity of the particle is defined by 4πS/L². Where S is the ortho-projected area of the particle and L is the perimeter of the ortho-projected image of the particle. The circularity of the particles can be determined by observing the appearance of the particles by scanning electron microscopy (SEM), transmission electron microscopy (TEM) or optical microscopy. The circularity of the plurality of particles may be measured as an average value in the following manner.

(1) First, the particle size distribution of the particles is measured. Specifically, the 10% cumulative particle diameter (D10) and the 90% cumulative particle diameter (D90), in the volume-based particle size distribution by laser diffraction/scattering are determined.

(2) The outer appearance of the particles are observed in an image taken with a SEM, TEM or optical microscope, and 100 particles having a circle equivalent diameter (diameter of a circle having the same area as the orthographic area of the particle) of D10 or greater and D90 or lower as determined in (1) above are arbitrarily selected from among the particles in the image.

(3) The circularity of each of the 100 selected particles is determined by image processing, and the average is considered to be the “circularity of the particles”.

### 1.5 Other

As described above, the positive electrode active material according to an embodiment has a large capacity by including the above-described Li containing oxide particles. From the viewpoint of further improving the capacity as a positive electrode active material, the content of the Li containing oxide particles contained in the positive electrode active material may be 50% by mass or more and 100% by mass or less, 60% by mass or more and 100% by mass or less, 70% by mass or more and 100% by mass or less, 80% by mass or more and 100% by mass or less, 90% by mass or more and 100% by mass or less, 95% by mass or more and 100% by mass or less, or 99% by mass or more and 100% by mass or less, and the positive electrode active material may be made of the above-described Li containing oxide particles.

### 2. Method of Manufacturing Positive Electrode Material

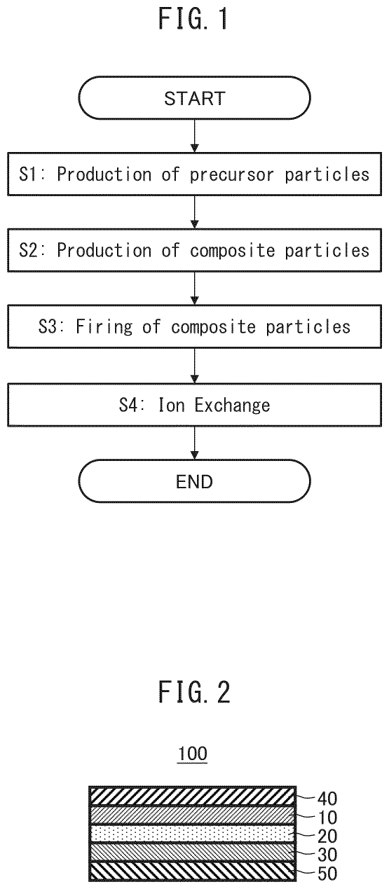

The Li containing oxide particles according to the above embodiment can be produced, for example, by the following methods. As shown in FIG. 1, the method of manufacturing a positive electrode active material according to an embodiment comprises,
S1: obtaining precursor particles comprising at least one element of Mn, Ni and Co,
S2: coating the surface of the precursor particles with a Na source to obtain composite particles,
S3: main firing the composite particles to obtain Na containing oxide particles having P2 type structures, and
S4: contacting an ion-exchange material with the Na containing oxide particles and ion-exchanging Na of the Na containing oxide particles with Li to obtain Li containing oxide particles having O2 type structures.

Here,
the temperature of the main firing is 700° C. or higher and lower than 950° C.,
the particle diameter D50 of the Na containing oxide particles is more than 0 μm and 3.0 μm or less,
the particle diameter D90 of the Na containing oxide particles is 2.0 μm or more and 6.0 μm or less,
the temperature of the ion exchanging is the melting point of the ion-exchange material or more and 300° C. or less, and
the time of the ion exchanging is 30 μminutes or more and less than 3 hours.

### 2.1 S1

In S1, precursor particles comprising at least one element of Mn, Ni and Co are obtained. The precursor particles may include at least Mn, one or both of Ni and Co, or may include at least Mn, Ni and Co. The precursor particles may be salts comprising at least one element of Mn, Ni and Co. For example, the precursor particles may be at least one of carbonate, sulfate, nitrate and acetate. Alternatively, the precursor particles may be a compound other than a salt. For example, the precursor particles may be a hydroxide. The precursor particles may be hydrates. The precursor particles may be a combination of a plurality of types of compounds. The particle diameter of the precursor particles is not particularly limited. In S1, an ion source capable of forming a precipitate with a transition metal ion in an aqueous solution and a transition metal compound containing at least one element of Mn, Ni and Co may be used, and a precipitate as the above-mentioned precursor particles may be obtained by a coprecipitation method. “An ion source capable of forming a precipitate with a transition metal ion in an aqueous solution” may be, for example, at least one selected from sodium salts such as sodium carbonate and sodium nitrate, sodium hydroxide, and sodium oxide. The transition-metal compound may be a salt, a hydroxide, or the like as described above comprising at least one element of Mn, Ni and Co. Specifically, in S1, the ion source and the transition-metal compound may be used as a solution, and then the solution may be dropped and mixed to obtain a precipitate as a precursor particle. At this time, for example, water is used as the solvent. At this time, various sodium compounds may be used as the base, and an aqueous ammonia solution or the like may be added to adjust the basicity. In the case of the coprecipitation method, for example, an aqueous solution of a transition metal compound and an aqueous solution of sodium carbonate are prepared, and each aqueous solution is added dropwise and mixed to obtain spherical precursor particles. Alternatively, it is also possible to obtain precursor particles by a sol-gel method. In S1, the precursor-particles may contain an element M. Element M is at least one of B, Mg, Al, K, Ca, Ti, V, Cr, Cu, Zn, Ga, Ge, Sr, Y, Zr, Nb, Mo and W. These element M has, for example, a function of stabilizing a P2 type structure or an O2 type structure. A method of obtaining a precursor containing an element M is not particularly limited. When a precursor is obtained by a coprecipitation method in S1, for example, an aqueous solution of a transition-metal compound containing at least one of Mn, Ni and Co, an aqueous solution of sodium carbonate, and an aqueous solution of a compound of element M are prepared, and each aqueous solution is added dropwise and mixed, whereby a precursor containing element M together with at least one element of Mn, Ni and Co is obtained. Alternatively, in the manufacturing process of the present disclosure, the element M may not be added in S1, and the element M may be doped when Na doping firing is performed in S2 and S3 described later.

### 2.2 S2

In S2, the surface of the precursor particles obtained by S1 is coated with a Na source to obtain composite particles. The Na source may be a salt containing a Na such as a carbonate or a nitrate, or may be a compound other than a salt such as sodium oxide or sodium hydroxide. In S2, the quantity of Na source to be coated on the surface of the precursor particles may be determined by taking into account Na loss during subsequent firing. In S2, the coverage of Na source relative to the surface of the precursors is not particularly limited. For example, in S2, the composite particles above may be obtained by covering 40% by area or more, 50% by area or more, 60% by area or more, or 70% by area or more of the surface of the above-mentioned precursor particles with the Na source. When the coverage of Na source is small, when the composite particles are fired, P2 type crystals tend to grow in a particular direction on the surface of the composite particles, and Na containing oxide tends to be plate-like. When the coverage of Na source is large, when the composite particles are fired, the crystallites of P2 type crystals tend to be small, and Na containing oxide particles tend to correspond to the shapes of the precursor particles. In S2, there is no particular limitation on the manner in which the surface of the above-described precursor particles is coated with a Na source. As described above, when 40% by area or more of the surface of the precursor particles is coated with a Na source, examples of the method include a rolling flow coating method and a spray drying method. That is, a coating solution in which a Na source is dissolved is prepared, and the coating solution is brought into contact with the surface of the precursor particles at the same time or after being brought into contact with each other, and then dried. By adjusting the coating conditions (temperature, time, number of times, etc.), 40 area % or more of the surface of the precursor particles can be coated with a Na source. In S2, the M source may be coated together with Na source to the precursor-particles. For example, in S2, a precursor particle obtained by S1, a Na source, and an M source containing an element M may be mixed to obtain a composite particle. The M source may be, for example, a salt containing an element M such as a carbonate or a sulfate, or a compound other than a salt such as an oxide or a hydroxide.

### 2.3 S3

In S3, by performing the main firing on the composite particles obtained by S2, Na containing oxide particles having P2 type structures are obtained. S3 may be provided with the following S3-1 to S3-3.

In S3-1, the composite-particles are subjected to preliminary firing at a temperature of 300° C. or higher and 700° C. or lower, for 2 hours or more and 10 hours or less. Preliminary firing temperature may be 400° C. or more and less than 700° C., 450° C. or more and less than 700° C., 500° C. or more and less than 700° C., 550° C. or more and less than 700° C., or 550° C. or more and 650° C. or less. In addition, the preliminary firing time may be 2 hours or more and 8 hours or less, 3 hours or more and 8 hours or less, 4 hours or more and 8 hours or less, 5 hours or more and 8 hours or less, or 5 hours or more and 7 hours or less. The preliminary firing atmosphere is not particularly limited, and may be, for example, an oxygen-containing atmosphere.

In S3-2, following the preliminary firing described above, the composite particles are subjected to the main firing. The temperature of the main firing is 700° C. or higher and 950° C. or lower, and may be 800° C. or higher and 920° C. or lower. If the main firing temperature is too low, P2 phase is not generated. Further, if the main firing temperature is too high, Na tends to remain after ion-exchange in S4. The temperature rising condition from the preliminary firing temperature to the main firing temperature is not particularly limited. The main firing time is not particularly limited, and may be, for example, 30 μminutes or more and 48 hours or less, 30 minutes or more and 24 hours or less, 30 μminutes or more and 10 hours or less, or 30 μminutes or more and 3 hours or less. However, the shapes of Na containing oxides can be controlled by the main firing times. As described above, in the process of the present disclosure, when the coverage of Na source on the composite particles is 40 area % or more, when the composite particles are fired, small P2 type crystals of crystallites tend to be formed on the surface thereof. In the presently disclosed process, by growing P2 type crystals along the surface of the particles so that one P2 type crystallite and another P2 type crystallite are connected to each other, the shape of Na containing oxide particles corresponds to the shape of the precursor particles. For example, when the precursor particles are spherical, Na containing oxide particles can also be spherical. If the main firing time is too short, the formation of P2 phase becomes insufficient. On the other hand, if the main firing time is too long, P2 phase grows, resulting in plate-like particles rather than spherical particles. As long as the present inventor has confirmed, when the main firing time is 30 μminutes or more and 3 hours or less, Na containing oxide particles tend to be spherical. Na containing oxide particles obtained after the main firing may have a structure in which a plurality of crystallites are present on the surface and the crystallites are connected to each other.

In S3-3, following the main firing described above, the composite particles after the main firing, from a temperature T₁ of 200° C. or higher to a temperature T₂ of 100° C. or less, high-speed cooling (cooling at a temperature lowering rate 20° C./min or higher). Preliminary firing or main firing of the above, for example, is performed in a heating furnace. In S3-3, for example, after the main firing of the composite particles is performed in a heating furnace, the composite particles are cooled to an arbitrary temperature T₁ of 200° C. or higher in the heating furnace, and after the temperature T₁ is reached, the fired product is taken out from the inside of the heating furnace, and the high-speed cooling is performed to an arbitrary temperature T₂ of 100° C. or less outside the furnace. The temperature T₁ is any temperature of 200° C. or higher and may be any temperature of 250° C. or higher. The temperature T₂ is an arbitrary temperature of 100° C. or less, may be an arbitrary temperature of 50° C. or less, and may be a cooling-end temperature. In a predetermined temperature range from the temperature T₁ to the temperature T₂, moisture easily enters between the areas of P2 type structure by atomic vibration, molecular motion, or the like. It is considered that, when the composite particles (Na containing oxide particles having P2 type structure) after the main firing are cooled, the amount of moisture entering into the interlayer of P2 type structure is reduced by making a time in which such moisture easily enters a short time (that is, high speed cooling). In this respect, in S3-3, when cooling the composite particles after the main firing, from an arbitrary temperature T₁ of 200° C. or more to an arbitrary temperature T₂ of 100° C. or less, by performing the cooling in a dry atmosphere outside the furnace, the cooling rate during the period from the temperature T₁ to the temperature T₂ becomes high speed (e.g., 20° C./min or higher), it becomes difficult for moisture to enter between the layers of P2 type structure, and it is possible to suppress the collapse P2 type structure. As a consequence, in S4, Na can be efficiently ion-exchanged into Li, and the residual Na quantity after ion-exchange is easily reduced.

By the above methods, it is possible to produce Na containing oxide particles having a P2 type structure and having a predetermined chemical composition. Na containing oxide may have a chemical composition represented by Na_{c}Mnₓ₋ₚNi_{y-q}Co_{z-r}M_{p+q+r}O₂. Here, 0.10≤c≤1.00, x+y+z=1, and 0≤p+q+r<0.17. Further, M is at least one of B, Mg, Al, K, Ca, Ti, V, Cr, Fe, Cu, Zn, Ga, Ge, Sr, Y, Zr, Nb, Mo and W. When Na containing oxide particles have such a chemical composition, P2 type structure is easily maintained. In the above chemical composition, c may be 0.10 or more, 0.20 or more, 0.30 or more, 0.40 or more, 0.50 or more, or 0.60 or more, and may be 1.00 or less, 0.90 or less, 0.80 or less, or 0.70 or less. The x, y, z, p, q and r are as described above.

Further, Na containing oxide particles obtained by the above methods have a particle size distribution. In this embodiment, performing the airflow classifying with respect to the above-described precursor particles, performing airflow classification with respect to the above-described composite particles, or by performing airflow classification with respect to Na containing oxide particles, etc., to obtain Na containing oxide particles having a predetermined D50 and D90, and obtained Na containing oxide particles are used in S4 described later. Thus, Li containing oxide particles having a predetermined D50 and D90 are obtained. Specifically, the particle diameter D50 of Na containing oxide particles used in S4 is more than 0 μm and 3.0 μm or less, and the particle diameter D90 is 2.0 μm or more and 6.0 μm or less. The particle diameter D50 μmay be 0.2 μm or more and 2.8 μm or less, 0.4 μm or more and 2.6 μm or less, 0.6 μm or more and 2.4 μm or less, 0.8 μm or more and 2.2 μm or less, or 1.0 μm or more and 2.0 μm or less. In addition, the particle diameter D90 μmay be 2.3 μm or more and 5.5 μm or less, 2.5 μm or more and 5.0 μm or less, 2.7 μm or more and 4.5 μm or less, or 2.9 μm or more and 4.0 μm or less. Further, the particle diameter D10 of Na containing oxide particles may be more than 0 μm and 2.0 μm or less. The particle diameter D10 μmay be 0.1 μm or more and 1.9 μm or less, 0.2 μm or more and 1.8 μm or less, 0.3 μm or more and 1.7 μm or less, 0.4 μm or more and 1.6 μm or less, or 0.5 μm or more and 1.5 μm or less.

### 2.4 S4

In S4, by contacting the ion exchange material with Na containing oxide particles obtained by S3, Na of the Na containing oxide particles is ion-exchanged into Li to obtain Li containing oxide particles having O2 type structure. Examples of the ion exchange material include a mixture of lithium halide and other lithium salts (e.g., molten salt). The lithium halide constituting the molten salt is preferably at least one of lithium chloride, lithium bromide and lithium iodide. The other lithium salt constituting the molten salt is preferably lithium nitrate. By using a molten salt, the melting point becomes lower than when lithium halide or other lithium salt is used alone, and ion exchange at a lower temperature becomes possible. The temperature in ion exchange is not less than the melting point of the ion exchange material described above and not more than 300° C. If the temperature of the ion-exchange is too high, an O3 type structure which is a stable phase is easily generated rather than an O2 type structure. On the other hand, from the viewpoint of making the time of ion exchange a short time, the temperature of ion exchange should be as high as possible. The time of ion exchange is 30 μminutes or more and less than 3 hours. If the time of ion-exchange of the ion-exchange is too short, the residual Na content in the Li containing oxide particles increases. On the other hand, if the time of ion-exchange is too long, an O3 type structure or the like is easily generated together with an O2 type structure.

### 3. Lithium-Ion Secondary Battery

FIG. 2 shows schematically the configuration of the lithium ion secondary battery according to one embodiment. As shown in FIG. 2, a lithium ion secondary battery 100 according to an embodiment includes a positive electrode active material layer 10, an electrolyte layer 20, and a negative electrode active material layer 30. Here, the positive electrode active material layer 10 includes a positive electrode active material according to the above-described embodiment. As shown in FIG. 2, the lithium ion secondary battery 100 may include a positive electrode current collector 40 and a negative electrode current collector 50. In the lithium ion secondary battery 100, the configuration other than the positive electrode active material is the same as in the prior art, and for example, the configuration described in Patent Document 1 (JP 2010-092824 A) can be adopted.

### EXAMPLES

As described above, a positive electrode active material, a method of manufacturing a positive electrode active material, and an embodiment of a lithium ion secondary battery have been described, but the technique of the present disclosure can be variously modified other than the above-described embodiment without departing from the gist thereof. Hereinafter, the technique of the present disclosure will be described in further detail with reference to Examples, but the technique of the present disclosure is not limited to the following Examples.

### 1. Preparation of Positive Electrode Active Material

### 1.1 Example 1

### 1.1.1 Preparation of Precursor Particles

(1) After weighing out MnSO₄·5H₂O and FeSO₄·7H₂O to the target compositional ratio, they were dissolved in distilled water to a concentration of 1.2 μmol/L to obtain a first solution. In a separate container, Na₂CO₃ was dissolved in distilled water to a concentration of 1.2 μmol/L to obtain a second solution.

(2) A 500 μmL portion of the first solution and a 500 μmL portion of the second solution were each added dropwise at a rate of about 4 μmL/min into a reactor (with baffle board) already containing 1000 μmL of purified water.

(3) Upon completion of the dropwise addition, the mixture was stirred for 1 h at room temperature at a stirring speed of 150 rpm to obtain a product.

(4) The product was washed with purified water and subjected to solid-liquid separation using a centrifugal separator to obtain a precipitate.

(5) The resulting precipitate was dried overnight at 120° C., and was divided into coarse particles and fine particles by air flow classification after mortar grinding. Here, both coarse particles and fine particles, a composite salt containing Mn, Ni and Co. In Example 1, as the precursor particles, the above fine particles were used.

### 1.1.2 Preparation of Composite Particles

The surface of the precursor particles was coated with Na₂CO₃ by weighing and mixing the precursor particles and Na₂CO₃ so that the aimed composition after firing described later became Na_{0.7}Mn₀Ni_{0.2}Co_{0.3}O₂, thereby obtaining composite particles.

### 1.1.3 Firing of Composite Particles

Composite particles were placed in alumina crucibles and fired in an atmosphere to obtain Na containing oxides with P2 type structure. Firing conditions are as follows (1) to (7).

(1) An alumina crucible containing the above composite particles is installed in a heating furnace in an air atmosphere.

(2) Raising the temperature in the heating furnace from room temperature (25° C.) to 600° C. in 115 μminutes.

(3) Pre-firing by holding the heating furnace at 600° C. for 360 μminutes.

(4) After pre-firing, raising the temperature in the heating furnace in 60 μminutes to 900° C. from 600° C.

(5) Main firing by holding the heating furnace for 60 μminutes at 900° C.

(6) After main firing, the heating furnace is cooled in 130 μminutes to 250° C. from 900° C.

(7) The alumina crucible is taken out from the heating furnace at 250° C., and allowed to cool in a dry atmosphere outside the furnace.

The product after cooling was pulverized using a mortar in a dry atmosphere to obtain Na containing oxide particles A having P2 type structure. The chemical composition and particle size D10, D50 and D90 of Na containing oxide particles A are as shown in Table 1 below.

### 1.1.4 Ion Exchange

(1) LiNO₃ and LiCl were weighed to a molar ratio of 50:50 and mixed with the above Na containing oxide particles A at a molar ratio of 10 times the minimum Li required for ion-exchange to obtain a mixture.

(2) Using an alumina crucible, ion-exchange was performed in an atmosphere at 280° C. for 1 hours to obtain a product containing Li containing oxide particles.

(3) The salt remaining in the product was washed with pure water and solid-liquid separated by vacuum filtration to obtain a precipitate.

(4) The obtained precipitate was dried overnight at 120° C., thereby obtaining a positive electrode active material according to Example 1

### 1.2 Comparative Example 1

### 1.2.1 Preparation of Precursor Particles and Composite Particles

Precursor particles and composite particles were obtained in the same manner as in Example 1

### 1.2.2 Firing of Composite Particles

Composite particles were placed in alumina crucibles and fired in an air atmosphere to obtain Na containing oxide particles having P2 type structure. Firing conditions are as follows (1) to (7).

(1) An alumina crucible containing the above composite particles is installed in a heating furnace in an air atmosphere.

(2) Raising the temperature in the heating furnace from room temperature (25° C.) to 600° C. in 115 μminutes.

(3) Pre-firing by holding the heating furnace at 600° C. for 360 μminutes.

(4) After pre-firing, raising the temperature in the heating furnace in 70 μminutes to 950° C. from 600° C.

(5) Main firing by holding the heating furnace for 60 μminutes at 950° C.

(6) After main firing, the heating furnace is cooled in 140 μminutes to 250° C. from 950° C.

(7) The alumina crucible is taken out from the heating furnace at 250° C., and allowed to cool in a dry atmosphere outside the furnace.

The product after cooling was pulverized using a mortar in a dry atmosphere to obtain Na content oxide particles B having P2 type structure. The chemical composition and particle diameter D10, D50 and D90 of Na containing oxide particles B are as shown in Table 1 below.

### 1.2.3 Ion Exchange

Except that Na containing oxide particles B were used instead of Na containing oxide particles A, ion-exchange was performed under the same conditions as in Example 1 to obtain a positive electrode active material according to Comparative Example 1

### 1.3 Comparative Example 2

### 1.3.1 Preparation of Precursor Particles and Composite Particles

Precursor particles and composite particles were obtained in the same manner as in Example 1

### 1.3.2 Firing of Composite Particles

Composite particles were placed in alumina crucibles and fired in an atmosphere to obtain Na containing oxides with P2 type structure. Firing conditions are as follows (1) to (7).

(1) An alumina crucible containing the above composite particles is installed in a heating furnace in an air atmosphere.

(2) Raising the temperature in the heating furnace from room temperature (25° C.) to 600° C. in 115 μminutes.

(3) Pre-firing by holding the heating furnace at 600° C. for 360 μminutes.

(4) After pre-firing, raising the temperature in the heating furnace in 80 μminutes to 1000° C. from 600° C.

(5) Main firing by holding the heating furnace for 60 μminutes at 1000° C.

(6) After main firing, the heating furnace is cooled in 150 μminutes to 250° C. from 1000° C.

(7) The alumina crucible is taken out from the heating furnace at 250° C., and allowed to cool in a dry atmosphere outside the furnace.

The product after cooling was pulverized in a mortar in a dry atmosphere to obtain Na containing oxide particles C having P2 type structure. The chemical composition and particle diameter D10, D50 and D90 of Na containing oxide particles C are as shown in Table 1 below.

### 1.3.3 Ion Exchange

Except that Na containing oxide particles C were used instead of Na containing oxide particles A, ion-exchange was performed under the same conditions as in Example 1 to obtain a positive electrode active material according to Comparative Example 2

### 1.4 Comparative Example 3

### 1.4.1 Preparation of Precursor Particles and Composite Particles

Precursor particles and composite particles were obtained in the same manner as in Example 1, except that the above coarse particles were used as precursor particles.

### 1.4.2 Firing of Composite Particles

Composite particles were placed in alumina crucibles and fired in an atmosphere to obtain Na containing oxides with P2 type structure. Firing conditions are as follows (1) to (7).

(1) An alumina crucible containing the above composite particles is installed in a heating furnace in an air atmosphere.

(2) Raising the temperature in the heating furnace from room temperature (25° C.) to 600° C. in 115 μminutes.

(3) Pre-firing by holding the heating furnace at 600° C. for 360 μminutes.

(4) After pre-firing, raising the temperature in the heating furnace in 80 μminutes to 1000° C. from 600° C.

(5) Main firing by holding the heating furnace for 1440 μminutes at 1000° C.

(6) After main firing, the heating furnace is cooled in 150 μminutes to 250° C. from 1000° C.

(7) The alumina crucible is taken out from the heating furnace at 250° C., and allowed to cool in a dry atmosphere outside the furnace.

The product after cooling was pulverized using a mortar in a dry atmosphere to obtain Na containing oxide particles D having a P2 type structure. The chemical composition and particle diameter D10, D50 and D90 of Na containing oxide particles D are as shown in Table 1 below.

### 1.4.3 Ion Exchange

Except that Na containing oxide particles D were used instead of Na containing oxide particles A, ion-exchange was performed under the same conditions as in Example 1 to obtain a positive electrode active material according to Comparative Example 3

### 1.5 Comparative Example 4

### 1.5.1 Preparation of Precursor Particles and Composite Particles and Firing of Composite Particles

Precursor particles and composite particles were obtained in the same manner as in Example 1, and then the composite particles were fired and pulverized under the same conditions as in Example 1 to obtain Na containing oxide particles E having P2 type structure. The chemical composition and particle diameter D10, D50 and D90 of Na containing oxide particles E are as shown in Table 1 below.

### 1.5.2 Ion Exchange

Except that Na containing oxide particles E were used instead of Na containing oxide particles A and the time of ion exchange was changed from 1 hour to 3 hours, ion exchange was performed under the same conditions as in Example 1 to obtain a positive electrode active material according to Comparative Example 4

### 1.6 Comparative Example 5

### 1.6.1 Preparation of Precursor Particles and Composite Particles and Firing of Composite Particles

Precursor particles and composite particles were obtained in the same manner as in Comparative Example 3, and firing and pulverizing the composite particles were performed under the same conditions as in Comparative Example 3 to obtain Na containing oxide particles F having a P2 type structure. The chemical composition and particle diameter D10, D50 and D90 of Na containing oxide particles F are as shown in Table 1 below.

### 1.6.2 Ion Exchange

Except that Na containing oxide particles F were used instead of Na containing oxide particles A and the time of ion exchange was changed from 1 hour to 3 hours, ion exchange was performed under the same conditions as in Example 1 to obtain a positive electrode active material according to Comparative Example 5

### 2. Evaluation of Positive Electrode Active Material

### 2.1 Elemental Analysis

For each of the positive electrode active materials of Example 1 and Comparative Examples 1 to 5, elemental analysis was performed to specify the chemical composition. The results are shown in Table 2 below.

### 2.2 Particle Size Distribution Measurement

For each of the positive electrode active materials of Example 1 and Comparative Examples 1 to 5, particle size distribution was measured, and the particle diameter D10, D50 and D90 were specified. The results are shown in Table 2 below.

### 2.3 Identification of Crystalline Structures by X Ray Diffractometry

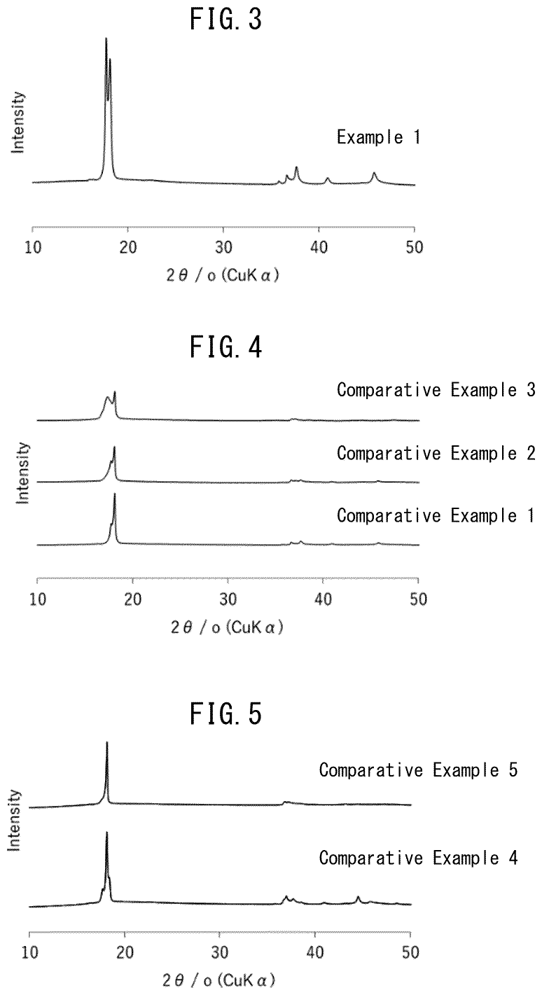

For each of the positive electrode active materials of Example 1 and Comparative Examples 1 to 5, X-ray diffraction measurement using CuKα as a ray source was performed to obtain an X-ray diffraction pattern. FIGS. 3 to 5 show the X-ray diffraction patterns of each of Example 1 and Comparative Examples 1 to 5. As shown in FIGS. 3 to 5, and it can be seen that the positive electrode active materials of any of Examples 1 and Comparative Examples 1 to 5 have a O2 type structure. Table 3 below shows the crystalline structures contained in the positive electrode active materials of each of Examples 1 and Comparative Examples 1 to 5 and the ratio I₂/I₁ of the X-ray diffraction peak intensity I₂ derived from the (003) plane of O3 type structure to the X-ray diffraction peak intensity I₁ derived from the (002) plane of O2 type structure.

### 3. Preparation of Evaluation Cell

Each of the positive electrode active materials of Example 1 and Comparative Examples 1 to 2 was used to prepare a coin cell. The procedure for preparing the coin cell is as follows.

(1) A positive electrode active material, acetylene black (AB) as a conductive aid, and polyvinylidene fluoride (PVdF) as a binder were weighed so as to be a positive electrode active material:AB:PVdF=85:10:5, and dispersed and mixed in N-methyl-2-pyrrolidone to obtain a positive electrode mixture slurry. A positive electrode mixture slurry was coated on an aluminum foil and vacuum-dried overnight at 120° C., thereby obtaining a positive electrode which is a laminate of a positive electrode active material layer and a positive electrode current collector.

(2) As an electrolytic solution, TDDK-217 (manufactured by Daikin Co., Ltd.) was prepared.

(3) A metal lithium foil was prepared as a negative electrode.

(4) A coin cell (CR2032) was prepared using the positive electrode, the electrolyte solution, and the negative electrode.

### 4. Charge/Discharge Characteristics Evaluation

Each coin cell, in a thermostatic bath held at 25° C., at 2.0-4.8V voltage-range, 0.1C (1C=220 μmA/g) was charged and discharged, and the discharge capacity was measured. The results are shown in Table 3 below.

### 5. Evaluation Results

Table 1 below shows the main firing temperature, chemical composition, particle diameter D10, D50, and D90 for each of Na containing oxide particles A to F used in Example 1 and Comparative Examples 1 to 5. Table 2 below shows ion-exchange times, chemical compositions, particle diameter D10, D50, and D90 of the positive electrode active materials of Example 1 and Comparative Examples 1 to 5, respectively. Table 3 below shows the crystalline structure contained in the positive electrode active material, I₂/I₁ specified from the X-ray diffraction pattern, and the discharge capacity of the evaluation cell for each of Example 1 and Comparative Examples 1 to 5

TABLE 1

| | Main | Chemical | | | | | | |
|---|---|---|---|---|---|---|---|---|
| | Firing | Composition | | | | | | |
| | Temp. | Na_{c}MnₓNi_{y}Co_{z}O₂ | | | | D10 | D50 | D90 |
| | [° C.] | c | x | y | z | [μm] | [μm] | [μm] |
| Particle | 900 | 0.71 | 0.51 | 0.19 | 0.30 | 1.0 | 1.9 | 3.6 |
| A | | | | | | | | |
| Particle | 950 | 0.70 | 0.51 | 0.19 | 0.30 | 1.2 | 2.4 | 4.4 |
| B | | | | | | | | |
| Particle | 1000 | 0.70 | 0.51 | 0.19 | 0.30 | 1.9 | 3.5 | 6.6 |
| C | | | | | | | | |
| Particle | 1000 | 0.68 | 0.54 | 0.17 | 0.29 | 3.6 | 8.4 | 17.8 |
| D | | | | | | | | |
| Particle | 900 | 0.71 | 0.52 | 0.18 | 0.30 | 0.9 | 1.8 | 3.6 |
| E | | | | | | | | |
| Particle | 1000 | 0.66 | 0.54 | 0.17 | 0.29 | 3.6 | 8.5 | 18.0 |
| F | | | | | | | | |

TABLE 2

| | Ion | Chemical | | | | | | | |
|---|---|---|---|---|---|---|---|---|---|
| | Exchange | Composition | | | | | | | |
| | Time | LiₐNa_{b}MnₓNi_{y}Co_{z}O₂ | | | | | D10 | D50 | D90 |
| | [hour] | a | b | x | y | z | [μm] | [μm] | [μm] |
| Ex. 1 | 1 | 0.68 | 0.00 | 0.51 | 0.19 | 0.30 | 1.0 | 1.9 | 3.7 |
| Comp. | 1 | 0.68 | 0.01 | 0.51 | 0.19 | 0.30 | 1.4 | 2.7 | 5.2 |
| Ex. 1 | | | | | | | | | |
| Comp. | 1 | 0.63 | 0.04 | 0.51 | 0.19 | 0.30 | 2.1 | 4.0 | 7.7 |
| Ex. 2 | | | | | | | | | |
| Comp. | 1 | 0.52 | 0.08 | 0.54 | 0.17 | 0.29 | 3.2 | 7.5 | 15.1 |
| Ex. 3 | | | | | | | | | |
| Comp. | 3 | 0.66 | 0.00 | 0.52 | 0.18 | 0.30 | 0.9 | 1.8 | 3.4 |
| Ex. 4 | | | | | | | | | |
| Comp. | 2 | 0.61 | 0.01 | 0.54 | 0.17 | 0.29 | 3.1 | 7.7 | 15.3 |
| Ex. 5 | | | | | | | | | |

TABLE 3

| | Crystal | | Discharge |
|---|---|---|---|
| | Structure | I2/I1 | Capacity [mAh/g] |
| Ex. 1 | O2, T#2 | 0 | 229 |
| Comp. Ex. 1 | O2, T#2 | 0 | 224 |
| Comp. Ex. 2 | O2, T#2 | 0 | 214 |
| Comp. Ex. 3 | O2, T#2 | 0 | 191 |
| Comp. Ex. 4 | O2, T#2, O3 | 0.56 | 212 |
| Comp. Ex. 5 | O2, T#2 | 0 | 221 |

As is apparent from the results shown in Tables 1 to 3, in Comparative Examples 1 to 3, since the main firing temperature at the time of preparing P2 type oxide particles was too high, the ion-exchange after the main firing did not sufficiently proceed, and Na remained in Li content oxide particles. Among them, in Comparative Examples 2 and 3, since the particle diameter of Na containing oxide particles after the main firing became too large, it was difficult for the ion-exchange to proceed further, and the residual Na content in Li containing oxide particles increased. In Comparative Example 5, since the particle diameter of Na containing oxide particles after the main firing became too large, even if the ion exchange time was a long time, Na remained in Li containing oxide particles after ion exchange. In Comparative Example 4, the particle diameter of Na containing oxide particles after the main firing was small, while the ion exchange time after the main firing was too long, so that an O3 phase was generated in Li containing oxide after the ion exchange. Due to these facts, Li containing oxide particles according to Comparative Examples 1 to 5 had a lower capacity as a positive electrode active material as compared with Li containing oxide particles according to Example 1. In contrast, Li content oxide particles according to Example 1 had a higher capacity as the positive electrode active material as a result of having an appropriate chemical composition, particle size, and crystalline structure.

### 6. Supplement

Note that, in the above examples, a case in which the precursor particles are obtained by a coprecipitation method has been exemplified, but the precursor particles can be obtained by a method other than this. In addition, in the above example, a case in which the precursor particles and Na source (Na₂CO₃) are mixed to obtain composite particles has been exemplified, but the composite particles can also be obtained by other methods. In addition, in the above example, a material having a predetermined chemical composition is exemplified as a P2 type structure Na containing oxide or a O2 type structure Li containing oxide, but the chemical composition of Na containing oxide or Li containing oxide is not limited thereto. For example, Na containing oxide or Li containing oxide may be doped with an element M other than Mn, Ni and Co. The element M is as described in the embodiment.

From the above findings, it can be said that Li containing oxide particles satisfying the following requirements (1) to (5) have a higher capacity as a positive electrode active material.

(1) Li content oxide particles have O2 type structure.

(2) Li containing oxide particles have chemical composition represented by LiₐNa_{b}Mnₓ₋ₚNi_{y-q}Co_{z-r}M_{p+q+r}O₂ (here, 0<a≤1.00, 0≤b<0.01, x+y+z=1, 0≤p+q+r<0.17, element M is at least one of B, Mg, Al, K, Ca, Ti, V, Cr, Fe, Cu, Zn, Ga, Ge, Sr, Y, Zr, Nb, Mo and W).

(3) The particle diameter D50 of Li containing oxide particles is more than 0 μm and 3.0 μm or less.

(4) The particle diameter D90 of Li containing oxide particles is 2.0 μm or more and 6.0 μm or less.

(5) The X-ray diffraction pattern of Li containing oxide particles satisfies 0≤I₂/110.5, wherein I₁ is an X-ray diffraction peak intensity derived from the (002) plane of O2 type structure, I₂ is an X-ray diffraction peak intensity derived from the (003) plane of O3 type structure.

### REFERENCE SIGNS LIST

100 Lithium-ion secondary battery
10 Positive electrode active material layer
20 Electrolyte layer
30 Negative electrode active material layer
40 Positive electrode current collector
50 Negative electrode current collector

1. A positive electrode active material, comprising Li containing oxide particles, wherein
the Li containing oxide particles have O2 type structures,
the Li containing oxide particles have a chemical composition represented by LiₐNa_{b}Mnₓ₋ₚNi_{y-q}Co_{z-r}M_{p+q+r}O₂ (where 0<a≤1.00, 0≤b<0.01, x+y+z=1, 0≤p+q+r<0.17, and element M is at least one of B, Mg, Al, K, Ca, Ti, V, Cr, Fe, Cu, Zn, Ga, Ge, Sr, Y, Zr, Nb, Mo and W),
the particle diameter D50 of the Li containing oxide particles is more than 0 μm and 3.0 μm or less,
the particle diameter D90 of the Li containing oxide particles is 2.0 μm or more and 6.0 μm or less, and
the X-ray diffraction pattern of the Li containing oxide particles satisfies 0≤I₂/I₁≤0.5, wherein
I₁ is X-ray diffraction peak intensity derived from (002) plane of the O2 type structure, and
I₂ is X-ray diffraction peak intensity derived from (003) plane of O3 type structure.

2. The positive electrode active material according to claim 1, wherein
the particle diameter D10 of the Li containing oxide particles is more than 0 μm and 2.0 μm or less.

3. A method of manufacturing a positive electrode active material, the method comprising:
obtaining precursor particles comprising at least one element of Mn, Ni and Co,
coating the surface of the precursor particles with a Na source to obtain composite particles, main firing the composite particles to obtain Na containing oxide particles having P2 type structures, and
contacting an ion-exchange material with the Na containing oxide particles and ion-exchanging Na of the Na containing oxide particles with Li to obtain Li containing oxide particles having O2 type structures, wherein
the temperature of the main firing is 700° C. or higher and lower than 950° C.,
the particle diameter D50 of the Na containing oxide particles is more than 0 μm and 3.0 μm or less,
the particle diameter D90 of the Na containing oxide particles is 2.0 μm or more and 6.0 μm or less,
the temperature of the ion exchanging is the melting point of the ion-exchange material or more and 300° C. or less, and
the time of the ion exchanging is 30 μminutes or more and less than 3 hours.

4. The manufacturing method according to claim 3, wherein
the particle diameter D10 of the Na containing oxide particles is more than 0 μm and 2.0 μm or less.

5. A lithium ion secondary battery, comprising a positive electrode active material layer, an electrolyte layer, and a negative electrode active material layer, wherein
the positive electrode active material layer comprises the positive electrode active material according to claim 1.
